(19) United States
(12) Patent Application Publication
(10) Pub. No.: US 2013/0153814 A1
(43) Pub. Date: Jun. 20, 2013

(54) Solution or Suspension Containing Fluoropolymer, Method for Producing Same, and Use Thereof for Producing Piezoelectric and Pyroelectric Coatings

(71) Applicants: Siegfried Bauer, Linz (AT); Gerhard Domann, Hoechberg (DE); Uta Helbig, Nuernberg (DE); Markus Krause, Altenberg (AT); Barbara Stadlober, Graz (AT); Martin Zirkl, Graz (AT)

(72) Inventors: Siegfried Bauer, Linz (AT); Gerhard Domann, Hoechberg (DE); Uta Helbig, Nuernberg (DE); Markus Krause, Altenberg (AT); Barbara Stadlober, Graz (AT); Martin Zirkl, Graz (AT)

(73) Assignees: Fraunhofer-Gesellschaft zur Foerderung der angewandten Forschung e.V., Muenchen (DE); JOANNEUM RESEARCH FORSCHUNGSGESELLSCHAFT MBH, Graz (AT)

(21) Appl. No.: 13/818,561

(22) PCT Filed: Aug. 12, 2011
(86) PCT No.: PCT/EP2011/063977

§ 371 Date: Feb. 22, 2013

(30) Foreign Application Priority Data
Aug. 27, 2010 (EP) 10174424.1

(51) Int. Cl. C09D 7/00

(52) U.S. Cl. CPC C09D 7/001
USPC 252/62.9 R; 524/111

(57) ABSTRACT

The invention relates to a method for producing a homogenous solution of a fluoropolymer, selected from fluoropolymers and fluoro-copolymers and mixtures of various fluoro-homopolymers and/or fluoro-copolymers in a high boiling solvent, whereby (a) the fluoropolymer to be dissolved is dissolved in a mixture of at least two solvents, the first comprising a boiling point of less than 150° C., and/or a vapor pressure of over 5 hPa (at 20° C.), and the second being a high boiling solvent comprising a boiling point at least 50 K higher than the first solvent and/or the boiling point thereof being selected so that the solvent mixture comprises a separation factor α of ≧1, and subsequently (b) the first solvent is substantially or completely removed from the mixture. The invention further relates to a method for producing suspensions of inorganic particles of a piezoelectrically and pyroelectrically active or activatable oxide in such fluoropolymer solutions and to the product of said method. The colorless fluoropolymer solutions and opaque white suspensions are suitable for producing laminar piezoelectric and pyroelectric coatings, in particular using doctor blade or screen printing methods.

The present invention relates to a homogeneous, fluoropolymer-based solution whose polymers can display piezoelectric and pyroelectric properties in crystalline status and which can additionally comprise a particle-like piezoelectric and pyroelectric inorganic material in suspended form, as well as a method for its manufacture. The polymer solution is suitable for the manufacture of large-size, possibly flexible, piezoelectric and pyroelectric layers by means of knife coating or screen printing methods.

Piezoelectric and pyroelectric materials link deformations or temperature changes with changes in the electrical load distribution. Inorganic piezoelectric and pyroelectric ceramics and monocrystals as well as organic polymers, including e.g. cane sugar and—predominantly—fluoropolymers have been disclosed. The materials whose individual crystallites can in each case already be piezoelectric and pyroelectric, obtain their corresponding macroscopic properties from a polarization step, if applicable, which compensates the difference in orientation of the crystallites. The latter materials are known as ferroelectric materials. Inorganic materials possess high piezoelectric and pyroelectric coefficients, but the disadvantages include extreme brittleness and high acoustic impedance. Inorganic piezoelectric and pyroelectric materials can be manufactured as compact ceramics or as thin films.

Components made of piezoelectric and pyroelectric ceramics are manufactured by means of sintering processes which require high temperatures. The high processing temperatures limit the selection of substrates for the synthesis of thin films. The temperatures can indeed be lowered with the use of special methods such as for example the sol-gel method combined with microwave or laser sintering; however, temperatures of close to 500° C. are generally required to achieve reasonably favorable material properties.

It is known that a range of halogenated polymers including PVC (polyvinyl chloride), PVF (polyvinyl fluoride) and in particular PVDF (polyvinylidene fluoride) possess piezoelectric, pyroelectric and usually also ferroelectric properties in certain crystalline conformations. Likewise, many co-polymers of these materials possess these types of properties, such as e.g. P(VDF/TFE) (TFE stands for tetrafluoroethylene), P(VDF/HFP) (HFP stands for hexafluoropropylene) P(VDF/TrFE) (TrFE stands for trifluoroethylene), P(VDF-CTFE) (CTFE stands for chlorotrifluoroethylene) or P(VDF/HFP/TFE). The addition in particular of smaller amounts of TrFE or TFE etc. to PVDF promotes the direct crystallization of the fluoropolymers into the β-phase from the molten mass. Said phase possesses the mentioned properties. Moreover, the subsequent drawing of the film such as is the case with PVDF homopolymers is not required with the addition of these kinds of comonomers.

The piezoelectric and pyroelectric polymers are flexible, possess a low density which is advantageous for impedance adjustments, while their piezoelectric and pyroelectric coefficients are comparatively low, wherein said coefficients are strongly dependent on the respective achievable crystal structure or the ratio of crystalline structure contained in the polymer. However, the piezoelectric properties of PVDF are at least more than ten times as high as those of quartz. Components made of organic piezoelectric and pyroelectric materials are commonly manufactured with foils. In the process, elevated temperatures are only required if the material is solubilized and the solvent subsequently has to be removed.

Attempts at linking inorganic and organic piezoelectric and pyroelectric materials and hence their advantageous properties have been made as early as in the 1970s of the last century. Manufacturing procedures, measuring methods and models to calculate the property profiles were developed, see Das-Gupta, D. K. (author): Ferroelectric Polymers and Ceramic-Polymer Composites. Trans Tech Publications Ltd., Switzerland, 1994. Common methods for the manufacture of PVDF-PZT composites include mixing the two components in a mill or adding the inorganic component to a polymer solution (see J. Zeng, Appl. Phys. 9 (2002), 2674-2679; Das-Gupta, Ioc.cit.; L. Jinhua et al., Preparation of PCLT/P(VDF-TrFE) pyroelectric sensor based on plastic film substrate, Sensors and Actuators A 100 (2002) 231-235; EP 1769544 A1) and possible subsequent processing by means of hot pressing.

Combining a ferroelectric polymer with a ferroelectric ceramics opens up the possibility to manufacture materials which are either only piezoelectric or only pyroelectric. A special poling method allows the setting of the polarization directions of both components to parallel or antiparallel. This helps either compensating or increasing the piezoelectric or pyroelectric effect (I. Graz et al., Flexible active-matrix cells with selectively poled bifunctional polymerceramic nanocomposite for pressure and temperature sensing skin, Journal of Applied Physics 106, 034503 (2009).

A range of solvents with more or less effective solvents have been disclosed for PVC, PVF and PVDF as well as their copolymers. They include cyclic ethers such as THF (tetrahydrofuran) and GBL (γ-butyrolactone; dihydrofuran-2-one), aliphatic ketones such as acetone, methyl ethyl ketone, 3-pentanon or 3-hexanone, cyclic ketones such as cyclohexanone, methyl cyclohexanone or isophorone, halogenated hydrocarbons such as trichloroethane or chlorodifluoromethane, esters such as propylene carbonate as well as triethyl phosphate, N-methylpyrrolidone, dimethylformamide and dimethyl sulfoxide. The piezoelectric and pyroelectric material polyvinylidene fluoride and its copolymers can be dissolved for example in acetone, N-methylpyrrolidone or dimethylformamide. All in all, looking at the solubility properties of these types of fluoropolymers reveals that solvents with a relatively low boiling point and analogously a relatively high vapor pressure are generally better solvents than the higher boiling/less volatile ones. However, to use a polymer solution in a knife coating and especially in a screen printing system, the solvent should have a low vapor pressure and a relatively high boiling point to prevent it from evaporating prematurely from the solution to be applied by doctor/to be printed, thus having a negative impact on its rheological properties or the dissolution of the polymer. Moreover, it is obviously desirable to work with solvents with a toxicity as low as possible, because print processes are usually performed on large substrates, e.g. a reel, and although the corresponding halls are equipped with exhausts, occupational safety procedures are obviously much more difficult to realize in large spaces than in small, lockable facilities. Therefore, no solvent has yet been identified which simultaneously provides the required solubility for the corresponding fluoropolymer, a very low vapor pressure as well as low toxicity.

Therefore, people were forced to work with relatively poorly soluble solvents. For instance, GBL has a relatively low vapor pressure (0.4 hPa at 20° C.) and a boiling point of 204-206° C. Moreover, it is non-toxic. Therefore, its properties as solvent for PVDF and its copolymers were analyzed quite closely. Consistent with the findings of M. Zirkl et al., Ferroelectrics 353, 173-185 (2007) and M. Zirkl, Manufacture and characterization of ferroelectric polymer thin films and their use in integrated organic infrared sensors, doctoral thesis, Graz, Austria, 2007, it was determined in the process that P(VDF-TrFE) is soluble to a certain extent in GBL at elevated temperatures (180° C.). However, the disadvantage of the described method is that combining the fluoropolymer with GBL creates an extremely viscous mixture, which is very difficult to stir and homogenization is therefore extremely problematic. As a result, the product is usually biphasic and additionally yellowish; the yellowish discoloration remains even if the phases are combined for dissolution. In the J. Appl. Polym. Sci. 65(8), 1517-1524 (1997), Tazaki et al. describe that PVDF can be dissolved in GBL among other things at a temperature of 180° C. A gel was created when the GBL solution was cooled. When reheated, said gel was thermoreversibly transformed into a sol. According to the authors, a crystal structure of the γ-type (TTTGTTTG conformation) was formed which is not relevant for the purpose of the present invention, while the β-phase was formed in cyclohexanone and no gel was formed at all in dimethylformamide. According to the authors, said gel formation was caused by the crystallization of the polymer. Accordingly, the synthesis of a solution with a defined concentration and hence a defined viscosity is difficult at least for standardized processes such as they are needed.

Solution-based printable composite precursors are described in M. Dietze et al., Sensors and Actuators A 143 (2008) 329-334. However, dimethylformamide, a toxic substance, is used as solvent here.

According to the literature, it can generally be helpful to use a plurality of solvents for dissolving paints, wherein the solvent with the highest boiling point must be best able to dissolve all starting materials contained in the paint. Cosolvents (“latent solvents”) which are only effective in the presence of the active solvent can be used in addition to said “active” or “true” solvent, see e.g. “Paints, coatings, and solvents” by Dieter Stoye and Werner Freitag (authors), Wiley-VHC Verlag GmbH Weinheim/Germany 1998, second completely revised edition (reprint 2001). Moreover, a low boiling point solvent, e.g. acetone is frequently used as auxiliary for the manufacture of a polymer dispersion, wherein the starting components are dissolved therein and said solvent is subsequently, i.e. after the establishment of the polymer, replaced with a dispersing agent, e.g. water and removed by means of distillation, see e.g. EP 849 298 A1, in which the manufacture of a polyurethane dispersion by means of said method is described. However, the low boiling point solvent is not used as cosolvent in these cases. For PVDF, the use of a cosolvent (CHClF₂) has so far only been described in connection with the use of supercritical CO₂, see H.-S Byun et al., Korean J. Chem. Eng. 21(6), 193-1198 (2204).

The object of the present invention is to provide a method by means of which clear, homogeneous solutions of fluoropolymers in high-boiling solvents can be obtained, which can subsequently be transformed into pyroelectric and piezoelectric active layers e.g. by means of printing methods.

Said object is solved in that the fluoropolymer to be dissolved, in particular PVDF or a copolymer of VDF and an additional fluoromonomer is dissolved in a mixture comprising at least two solvents, the first of which is a low boiling point solvent (having a boiling point of preferably below 150° C., more preferably below 100° C. and especially preferably below 75° C. and/or a vapor pressure of preferably above 5 hPa, more preferably above 25 hPa and even more preferably above 100 hPa at 20° C.) and the second of which is a high boiling point solvent (having a boiling point of preferably above 180° C. and/or a vapor pressure below 3, preferably below 1 hPa). The difference in the boiling temperature between the first and the second solvent should preferably be selected such that the separation factor is a 1 and preferably (to make the method economical) ≧1.04. Subject to an almost ideal behavior of the solvents, said factor is calculated according to the formula

$$log {α}_{1 , 2} = \frac{{T}_{S 2}^{*} - {T}_{S 1}^{*}}{{T}_{M}} \cdot ( 7 , 30 - 0 , 662 \cdot log {p}_{tot} + \frac{{T}_{M}}{103 \cdot log {p}_{tot}} )$$

a_{1,2} “relative volatility” or “separation factor”
T_{S2} boiling point of the highly viscous component
T*_{S1} boiling point of the volatile component
T_{M}, boiling point of the mixture
pₜₒₜ pressure in the system during distillation

Because information about the separability by means of simple distillation is often difficult to gather from the literature, it can be assumed as a rule of thumb that the boiling point of the high boiling point solvent should be at least 50° K higher than the one of the first solvent in the majority of cases. In preferred cases, the difference in the boiling point is close to ≧60° K, more preferably close to ≧70° K and particularly preferably close to ≧80° K, because this allows a separation by means of simple distillation. If the fluoropolymer is completely dissolved, the first solvent will be essentially completely or completely removed. In this context, “essentially” means that no more than 5% by volume, more preferably no more than 2% by volume of said solvent remain in the mixture.

In one preferred embodiment, both solvents are only slightly or non-toxic. This shall mean that they are not classified in one of the hazard classes “acute toxicity, category 1 to 3”, “carcinogenicity”, “mutagenicity” or “reproductive toxicity” as “highly toxic”, “toxic”, “carcinogenic”, “mutagenic” or “toxic to reproduction” within the meaning of the German Ordinance on the Protection against Hazardous Substances (Hazardous Substances Ordinance—GefStoffV) or a corresponding European regulation (CLP Regulation (EC) no. 1272/2008) or an American guideline and that their occupational exposure limit pursuant to the “Technical Rules for Hazardous Substances” (TRGS 900) is at least 200 mg per m³ and/or—in all cases—the LD₅₀ measured in the rat is not lower than 200 mg/kg (GefStoffV) or 300 mg/kg (CLP Regulation), respectively, if they are relatively highly volatile.

In one preferred embodiment that is independent from the above, the at least two solvents are mixed first before the polymer is added e.g. in the form of powder or granules.

Accordingly, the fluoropolymer (e.g. PVDF or a copolymer thereof) to be dissolved is dissolved in the form of a powder, granules or similar in at least two solvents, the first of which is a low boiling point highly soluble solvent and the second of which is a high boiling point solvent of relatively low solubility. This is preferably achieved in that the fluoropolymer is added to a mixture of the mentioned solvent. Subsequent stirring creates a clear homogenous solution. Stirring is preferably done at relatively mild temperatures, e.g. advantageously at room temperature or up to approximately 25° K or above. However, if the manufacture takes place at temperatures near the melting point of the polymer (which is close to 176° C. for PVDF and close to 154.5° C. for a copolymer consisting of PVDF and TrFE at a molar ratio of 70:30), this can have a negative impact on the reproducibility of the manufacture for some mixtures. Next, the low boiling point solvent is removed from the mixture at a temperature that is preferably not or only slightly elevated (for example 40° C.) and under vacuum, if necessary. A clear homogenous colorless solution is provided in this fashion, whose viscosity can be adjusted with the polymer content.

If exclusively the mentioned two solvents are used, they should preferably be used at a ratio between 80:20 and 20:80 (vol./vol.), more preferably at a ratio between 65:35 and 35:65 (vol./vol.) and particularly preferably at a ratio between 45:55 and 55:45 (vol./vol.). They can for instance be used at a ratio of 1:1 (vol./vol.).

Highly soluble suitable low boiling point solvents (cosolvents) include e.g. acetone with a boiling point of 56° C., tetrahydrofuran with a boiling point of 66° C., trichloroethane with a boiling point of 74° C. and cyclopentyl methyl ether (boiling point 106° C.). Among them, acetone is particularly preferred for reasons of health protection.

DMSO (b. p. 189° C.), triethyl phosphate (b. p. 215° C.), γ-butyrolactone, N-methylpyrrolidine (b. p. 203° C.), a cyclic ketone such as cyclohexanone (b. p. 156° C.), cyclopentanone (b. p. 131° C., vapor pressure 11 hPa), 3-methylcyclohexanone (b. p. 162-163° C.) or menthone-trans-2-isopropyl-5-methylcyclohexanone or a mixture of two or more of these solvents can be used for example as high boiling point, intermediate solvent. If the low boiling point solvent has a relatively low boiling point, it is possible to use a solvent with a relatively low boiling point as high boiling point solvent, such as cyclopenthyl methyl ether mentioned in the group of low boiling point solvents, as long as the difference between the boiling points of the two is at least 50 K.

Polymer solutions according to the invention exclusively comprising polymer and a high boiling point solvent, in particular γ-butyrolactone, are clear and colorless. In contrast, solutions produced by temperature exposure have a characteristic yellowish-green color. According to the invention, colored solutions should be avoided because it has been determined that they are not suitable for the manufacture of large-size layers or lead to lower quality products, especially in connection with knife coating and screen printing methods.

It is possible to manufacture a solution according to the invention which additionally comprises inorganic particles of a piezoelectrically and pyroelectrically active or activatable oxide (an oxide ceramics). Examples include PZT (lead zirconate titanate), BTO (barium titanate), PTO (lead titanate) and BNT-BT (bismuth sodium titanate-barium titanate). For this purpose, a suspension of the inorganic particles is first produced in a suitable, preferably low boiling point suspending agent, if necessary with the use of a common dispersing agent. The selection of the suspending agent per se is not critical; however, it should be ensured that the particles are well dispersible (for example by means of ultrasound). In addition, the suspending agent must be compatible with the PVDF or PVDF copolymer solution, i.e. polymeric precipitation must be prevented. Suitable solvents for this purpose include e.g. aliphatic ketones such as acetone or methyl ethyl ketone (among which methyl ethyl ketone is preferred) or some alcohols (ethanol can be mixed with a solution of the fluorinated polymer in GBL at a (weight/volume) ratio of up to about 1:1). The particle suspension can either be added to the intermediate product, i.e. the solution comprising the polymer and the solvent mixture, or to the polymer solution from which the low boiling point solvent has already been removed. Normally, the latter suspension has a low viscosity which can be reduced more as needed with the further addition of a low boiling point solvent (in particular one of those mentioned above for the manufacture according to the invention), such that the dispersion of the particles in the polymer solution can easily be carried out with suitable methods (for example by means of ultrasonic treatment). Next, the content of suspending agents and low boiling point solvent, if any is removed as described above. As a result, the viscosity of the solution increases again, thus inhibiting the particle sedimentation. To conserve the dispersion of the particles, a short period of time is advantageous for this work step.

Said type of solution, which is hereinafter also referred to as composite precursor, can be used to manufacture a composite material with the properties described above.

The polymer solution according to the invention or the composite precursor according to the invention can be applied to a substrate among other things by spin coating, by doctor or by processing on a screen printer. Thermal after-treatment is required to cure the layer by removing the solvent (generally at about 90° C.-110° C.; the duration of said after-treatment is not critical and generally ranges between 5 min to 5 h). The resulting ferroelectrical layers obtain their piezoelectric and pyroelectric properties from a subsequent poling step.

The invention is characterized in that the polymer solution can be mixed easily with a magnetic stirrer during the manufacture. A clear, colorless, homogeneous solution is created, whose polymer content can be adjusted. This way, it is easily possible to produce large quantities of homogeneous solutions with a suitable viscosity which can subsequently be used for printing processes or similar, because their flow properties are not changing during the printing process as a result of premature solvent evaporation. Moreover, the negative impact on the environment caused by solvent vapors is lower. Additional benefits under health-related aspects are achieved for the persons tasked with the printing or other further processing steps, especially if less toxic or completely harmless solvents are used as intermediate solvent. As an additional advantage, the polymer can be dissolved at room temperature. The cosolvent removed from the solvent mixture can subsequently be recovered and reused for the manufacture according to the invention.

If cosolvents are used for the manufacture of polymer solutions according to the prior art as explained above, the cosolvent generally remains in the mixture. Based on previous analyses on the manufacture of P(VDF-TrFE) layers used as sensors, it is known that it is particularly advantageous to use exclusively γ-butyrolactone as solvent for said polymer (see M. Zirkl and M. Zirkl et al., loc. cit.). The type of solvent or the solvent mixture affects the density and crystallinity and hence the electronic properties of the solid obtained after the solvent has evaporated. It is known that volatile solvents reduce the density of the polymer and cause “cavities” during the evaporation. As well, the crystallinity rises in connection with slow evaporation, which is an additional reason for the use of a high boiling point solvent proposed according to the invention. Thus, the removal of the cosolvent, e.g. the acetone from the mixture by means of the method according to the invention facilitates e.g. the manufacture of clear, colorless PVDF solutions in pure γ-butyrolactone or other fluoropolymers in only one high boiling point solvent. Fluoropolymer layers with a considerably higher quality (such as e.g. P(VDF-TrFE) layers from GBL) can be produced with said solutions than those disclosed in the prior art. Printable precursors for piezoelectric and pyroelectric composite materials are described for example in K. I. Arshak et al., Sensors and Actuators 79 (2000) 102-114, or Y. H. Son et al., Integrated Ferroelectrics, 88 (2007) 44-50. However, in both cases, the precursors are particle suspensions for which an after-treatment step at high temperatures (according to Arshak et al. 170° C., i.e. above the melting temperature of PVDF:TrEF (70:30), see above) may be required. Resulting piezoelectric and pyroelectric properties are not described in any of the two publications. However, less favorable property profiles, in particular less favorable electronic properties are expected because of the lower homogeneity of the applied layers compared with those consisting of solvent-based materials.

The advantage of the method according to the invention consists in the use of a generally less toxic solvent, the possibility of incorporating particles without further pre-treatment and in the favorable piezoelectric and pyroelectric properties of the resulting material. Furthermore, the method facilitates the defined setting of the viscosity and hence the adjustment to the application method, since the viscosity of the precursor is predominantly determined by the polymer content and hence by the originally weighed-in quantity.

### EXEMPLARY EMBODIMENT 1

### Polymer Solution

introduce 250 mL of γ-butyrolactone (GBL) and 250 mL of acetone into a 1 L one-necked bottle
stir for approx. 1 min using a magnetic stirrer
weigh-in 61.9 g of P(VDF-TrFE) granules
add the granules to the solvent mixture while stirring
stir for 24 h at room temperature (result: clear colorless fluid)
evaporation by rotation of acetone from the mixture (total duration approx. 5 h)
at 40° C. and with a pressure between 250 mbar and 2-3 mbar
   Result: clear, colorless solution with a viscosity of about 25 Pa's (at room temperature and a shear rate of 10 s⁻¹)

According to the exemplary embodiment, solutions with different fluoropolymer contents can be manufactured, by weighing in higher or lower quantities of P(VDF-TrFE) granules.

### EXEMPLARY EMBODIMENT 2

### Composite Precursor

### Manufacture of the Particle Suspension:

suspend for example 0.5 g of PbTiO₃ powder in 50 mL of methyl ethyl ketone, ultrasonic treatment for 1 h,
allow to sediment for 1 h,
pipette off approx. 30 g of the suspension
dry the suspension, determine the weight of the residue (example: 2.3 g)
re-suspend the PbTiO₃ powder in methyl ethyl ketone (example: 30 mL) by means of ultrasonic treatment (1 h)

### Manufacture of the Composite Precursor:

add the suspension to a corresponding quantity (example: 30 g) of polymer solution, manufacture according to exemplary embodiment 1
ultrasonic treatment for 1 h
remove methyl ethyl ketone from the mixture (by means of a rotary evaporator at 40° C.)
   Result: white opaque suspension with a viscosity of about 25 Pa's at room temperature and a shear rate of 10 s⁻¹

### EXEMPLARY EMBODIMENT 3

### Composite Precursor

Exemplary embodiment 2 was repeated with the change that bismuth sodium titanate-barium titanate (BNT-6BT) was used instead of PbTiO₃.

### EXEMPLARY EMBODIMENT 4

### Composite Precursor

Exemplary embodiment 3 was repeated with the change that 40 g of suspension was used instead of 30 g of suspension. The viscosity did not change as a result.

### EXEMPLARY EMBODIMENT 5

### Composite Precursor

Comparative example
heat 25 mL of GBL in a three-necked bottle to 180° C. with the use of a return condenser.
weigh in 18 percent in weight of PVDF:TrFE granules (5.076 g)
gradually add the granules to the solvent while stirring with a magnetic stirrer
stir for 2-3 h under the return condenser at 180° C.
cool the solution to <100° C.
bottle the solution and cool it to room temperature
   Result: yellowish solution with a viscosity of for example close to 40 Pa's (at room temperature and a shear rate of 10 s⁻¹)

The solutions synthesized based on the method according to the invention can be used for the manufacture of sensor layers. The techniques selected for this purpose are not critical; for example, it is possible to use knife coating, print or wet film coating methods such as e.g. spinning, dipping or spraying. Such sensors can be used for example as human machine interface, as so-called “electronic skin” and for monitoring buildings or systems. An example of a printing method is described below:

The solution of example one is printed by means of a common screen printing system, e.g. a model EKRA X1 semi-automatic screen printer. A polyester fabric screen with a mesh count of 110-34 cm/DIN (110 threads per cm with a thread thickness of 34 μm) and a polyurethane rubber film applicator with a Shore hardness of 65 are used for the printing process. The solution is applied in the form of printing ink. After the printing using common parameters, the layer is cured by means of thermal after-treatment at a temperature ranging between 90° C. and 110° C. for a duration of 5 min to 5 h.

The properties of the layer measured on a specimen were as follows:
residual polarization: 5-8 μC/cm²
pyroelectric coefficient (at RT): 40 μC/m²K
piezoelectric coefficient (d₃₃): 25 μC/N

In general, it is particularly beneficial to provide concentrations ranging between approximately 15 and approximately 30 percent in weight of fluoropolymer in the solvent for the printing process. In the case of the materials mentioned in exemplary embodiment 1, it was possible to use solutions comprising slightly less than 30 percent in weight of fluoropolymer for the screen printing process; at 30 percent in weight, the solution became too viscous for this method. Excellent screen printing qualities are achieved especially with concentrations ranging between 18 and approximately 25 percent in weight; the layers are electrically non-conductive and free of holes.

With the suspension of example 3, it was possible to print tear-free layers with a layer thickness of 4.7 μm; the same was true for the suspension of example 4, in which the achieved layer thickness was close to 5 μm.

The research this invention is based on was sponsored by the European Community's Seventh Framework Program [FP7/2007-2013] under grant agreement no. [215036].

1. A method for the manufacture of a homogeneous solution of a fluoropolymer, selected among fluoro-homopolymers and copolymers and mixtures of different fluoro-homopolymers and/or copolymers, in a high boiling point solvent, wherein
(a) the fluoropolymer to be dissolved is dissolved in a mixture comprising at least two solvents, the first of which has a boiling point below 150° C., and/or a vapor pressure above 5 hPa (at 20° C.) and the second of which is a high boiling point solvent having a boiling point that is at least 50° K higher than the one of the first solvent and/or the boiling point of which is selected such that the solvent mixture has a separation factor α of ≧1, and
(b) almost all or all of the first solvent is subsequently removed from the mixture.

2. A method according to claim 1, wherein the first solvent comprises a boiling point below 75° C. and/or a vapor pressure above 100 hPa (at 20° C.) and the second solvent has a boiling point above 180° C. and/or a vapor pressure below 3 hPa.

3. A method according to claim 1, characterized in that the at least two solvents are mixed first and the fluoropolymer to be dissolved is added to the solvent mixture.

4. A method according to claim 1, characterized in that the fluoropolymer is PVDF or a copolymer of vinylidene fluoride with an additional fluoride-containing monomer.

5. A method according to claim 1, characterized in that the first solvent is acetone and the second solvent is butyrolactone.

6. A method for the manufacture of a suspension of inorganic particles of a piezoelectrically and pyroelectrically active or activatable oxide in a homogeneous solution of a fluoropolymer, selected among fluoro-homopolymers and copolymers and mixtures of different fluoro-homopolymers and/or copolymers, in a high boiling point solvent, comprising the steps:
(a) manufacture of a suspension of the inorganic particles in a suspending agent,
(b) dissolution of the fluoropolymer in a mixture comprising at least two solvents, the first of which has a boiling point below 150° C., and/or a vapor pressure above 5 hPa (at 20° C.) and the second of which is a high boiling point solvent having a boiling point that is at least 50° K higher than the one of the first solvent and/or the boiling point of which is selected such that the solvent mixture has a separation factor α of ≧1,
(c) addition of the suspension of the inorganic particles to the solution of the fluoropolymer according to (b) and
(d) complete or almost complete removal of the first solvent and the suspending agent.

7. A method for the manufacture of a suspension of inorganic particles of a piezoelectrically and pyroelectrically active or activatable oxide in a homogeneous solution of a fluoropolymer, selected among fluoro-homopolymers and copolymers and mixtures of different fluoro-homopolymers and/or copolymers, in a high boiling point solvent, comprising the steps:
(a) manufacture of a suspension of the inorganic particles in a suspending agent,
(b) manufacture of a fluoropolymer solution, wherein
(1) the fluoropolymer to be dissolved is dissolved in a mixture comprising at least two solvents, the first of which has a boiling point below 150° C., and/or a vapor pressure above 5 hPa (at 20° C.) and the second of which is a high boiling point solvent having a boiling point that is at least 50° K higher than the one of the first solvent and/or the boiling point of which is selected such that the solvent mixture has a separation factor α of ≧1, and
(2) almost all or all of the first solvent is subsequently removed from the mixture,
(c) addition of the suspension of the inorganic particles to the solution of the fluoropolymer according to (b) and
(d) complete or almost complete removal of the suspending agent.

8. A method according to claim 6, characterized in that the suspending agent has a boiling point below 120° C., preferably below 100° C.

9. A method according to claim 8, characterized in that the suspending agent is selected from among aliphatic ketones as well as mixtures of aliphatic ketones or mixtures of one or a plurality of solvents with aliphatic ketones.

10. A method according to claim 9, wherein the suspending agent is methyl ethyl ketone.

11. A method according to claim 6, characterized in that the fluoropolymer is PVDF or a copolymer of vinylidene fluoride with an additional fluoride-containing monomer.

12. A method according to claim 6, wherein the first solvent has a boiling point below 75° C. and/or a vapor pressure above 100 hPa (at 20° C.) and the second solvent has a boiling point above 180° C. and/or a vapor pressure below 3 hPa.

13. A method according to claim 12, characterized in that the first solvent is acetone, the second solvent is butyrolactone and the suspending agent is an aliphatic ketone with a boiling point below 120° C. and is preferably methyl ethyl ketone.

14-17. (canceled)
